(19) United States
(12) Patent Application Publication
(10) Pub. No.: US 2020/0068849 A1
(43) Pub. Date: Mar. 5, 2020

(54) DOG BATH TUB

(71) Applicant: Russell Lee Caldwell, Garden Prairie, IL (US)

(72) Inventor: Russell Lee Caldwell, Garden Prairie, IL (US)

(21) Appl. No.: 16/119,004

(22) Filed: Aug. 31, 2018

(51) Int. Cl. A01K 13/00; A47K 3/022

(52) U.S. Cl. CPC A01K 13/001; A47K 3/022

(57) ABSTRACT

A dog bath tub including a base having a length greater than a width. Sidewalls upstand from opposing sides of the base along the length, and from a first end of the base along the width. An access door is disposed at a second end of the base opposite the first end. The access door includes a first side and a second side. The first side is coupled to one of the sidewalls by a hinge and the second side includes a stop configured to engage another of the sidewalls.

### BACKGROUND OF THE INVENTION

The present invention relates to washing dogs and, more particularly, to a dog bath tub.

Dog grooming refers to both the hygienic care and cleaning of a dog. Shampoos and conditioners are common grooming supplies used by every dog owner. Owners are recommended to use only shampoos, conditioners and rinses that are especially designed for dogs. Bath tubs are supplies more commonly found in professional grooming shops. They are made of a variety of materials, including galvanized steel. Current bath tubs include a hinged door at the front that swings outward and away from the tub. This allows dogs to escape from the tub if the latch is not secured. Further, the large swinging door may pinch either the washer or the dog at the hinge.

As can be seen, there is a need for an improved dog bath tub.

### SUMMARY OF THE INVENTION

In one aspect of the present invention, a dog bath tub comprises: a base comprising a length greater than a width; sidewalls upstanding from opposing sides of the base along the length, and from a first end of the base along the width; an access door disposed at a second end of the base opposite the first end and comprising a first side and a second side, wherein the first side is coupled to one of the sidewalls by a hinge and the second side comprises a stop configured to engage another of the sidewalls, wherein the access door pivots inwards towards the base and the stop prevents the access door from pivoting outwards away from the base.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a top view of an embodiment of the present invention;

FIG. 3 is a section view of the present invention, taken along line 3-3 of FIG. 2; and

FIG. 4 is a detailed section view of the present invention, taken along line 4-4 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

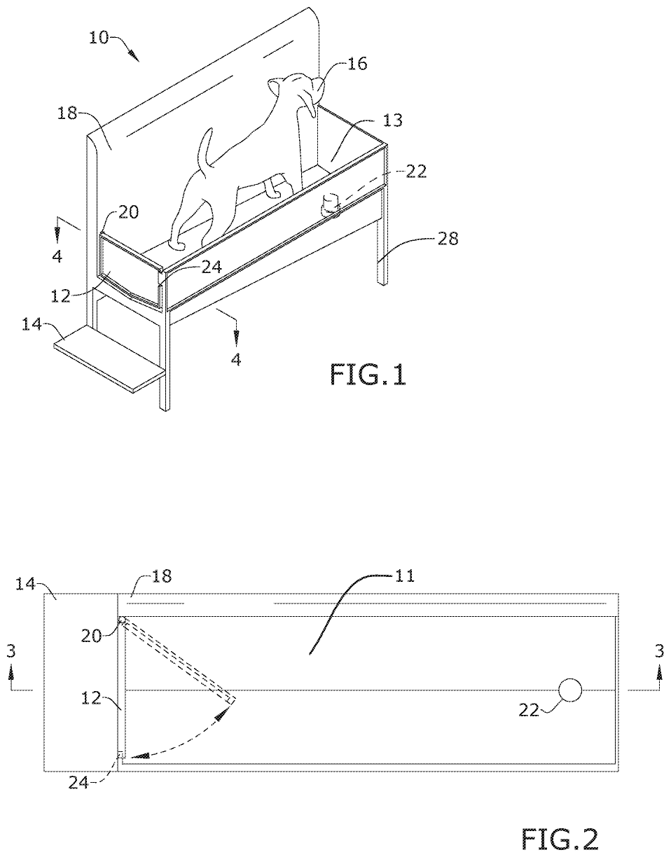

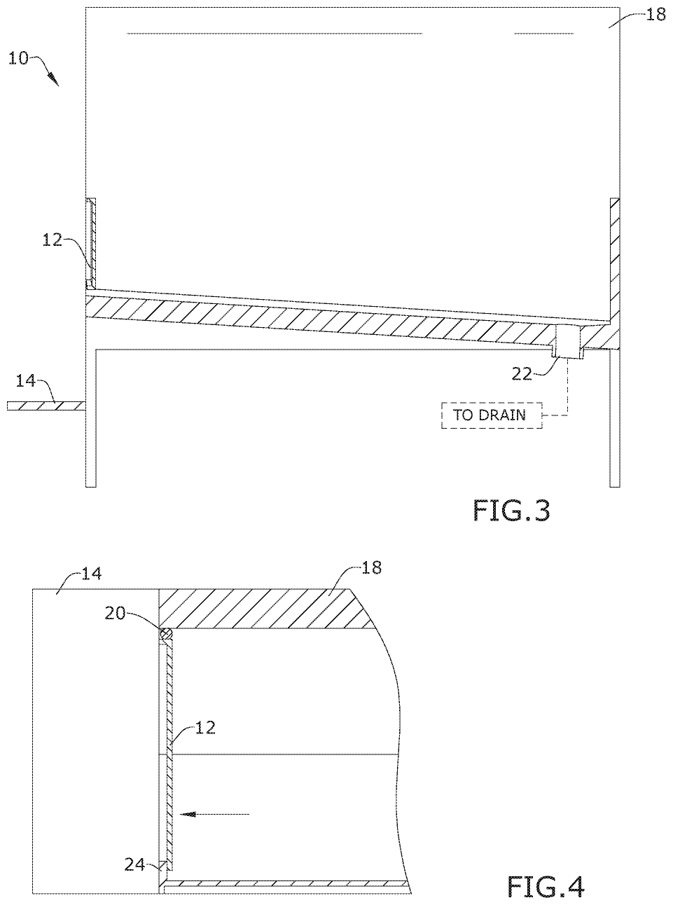

Referring to FIGS. 1 through 4, the present invention includes a dog bath tub 10. The dog bath tub 10 includes a base 11 having a length greater than a width. Sidewalls 13 upstand from opposing sides of the base along the length, and from a first end of the base 11 along the width. An access door 12 is disposed at a second end of the base 11 opposite the first end. The access door 12 includes a first side and a second side. The first side is coupled to one of the sidewalls 13 by a hinge 20 and the second side includes a stop 24 configured to engage another of the sidewalls 13.

The access door 12 of the present invention may only pivot inwards towards the base 11. The stop 24 prevents the access door 12 from pivoting outwards away from the base. This prevents the dog 16 from escaping the bath 10 through the access door 12 when the access door 12 is not locked closed. Further, since the access door 12 is at an end of the tub 10, instead of along a side, the access door 12 is less likely to pinch either the dog 16 or the dog groomer when opening and closing the access door 12.

In certain embodiments, the tub 10 includes a tub drain 22 formed through the base 11. An upper surface of the base 24 may be sloped towards the tub drain 11. Therefore, the water may be directed towards the drain 22 and exit the tub 10 through the drain 22.

The tub 10 may further include plurality of legs 28 coupled to and extending from a bottom of the base 13. The plurality of legs 28 support the base 11 in an elevated position. Therefore, the dog groomer does not have to bend over when washing the dog 16. A step 14 may be coupled to the plurality of legs 28 and may be disposed below the access door 12. The step 14 allows the dog 16 to step up and into the tub 10 when the access door 12 is open.

The tub 10 may further include a back sidewall 18. The back sidewall 18 is one of the sidewalls 13 that extends along the length of the base 13. The back sidewall 18 has a height that is greater than the other of the plurality of sidewalls 13.

It should be understood, of course, that the foregoing relates to exemplary embodiments of the invention and that modifications may be made without departing from the spirit and scope of the invention as set forth in the following claims.

What is claimed is:

1. A dog bath tub comprising:
a base comprising a length greater than a width;
sidewalls upstanding from opposing sides of the base along the length, and from a first end of the base along the width;
an access door disposed at a second end of the base opposite the first end and comprising a first side and a second side, wherein the first side is coupled to one of the sidewalls by a hinge and the second side comprises a stop configured to engage another of the sidewalls, wherein
the access door pivots inwards towards the base and the stop prevents the access door from pivoting outwards away from the base.

2. The dog bath tub of claim 1, further comprising a tub drain formed through the base.

3. The dog bath tub of claim 2, wherein an upper surface of the base is sloped towards the tub drain.

4. The dog bath of claim 1, further comprising a plurality of legs coupled to and extending from a bottom of the base and supporting the base in an elevated position.

5. The dog bath of claim 4, further comprising a step coupled to the plurality of legs and disposed below the access door.

6. The dog bath of claim 1, wherein one of the plurality of sidewalls extending along the length comprises a height greater than the other of the plurality of sidewalls.
